(19) United States
(12) Patent Application Publication
(10) Pub. No.: US 2011/0103846 A1
(43) Pub. Date: May 5, 2011

(54) Developer storage container, developing device and image forming apparatus

(75) Inventor: Atsushi Ota, Tokyo (JP)

(73) Assignee: OKI DATA CORPORATION, Tokyo (JP)

(21) Appl. No.: 12/926,220

(22) Filed: Nov. 3, 2010

(30) Foreign Application Priority Data
Nov. 4, 2009 (JP) 2009-252754

(51) Int. Cl. G03G 15/08

(52) U.S. Cl. 399/263

(57) ABSTRACT

A developer storage container includes a developer storage portion that stores a developer and has an opening for supplying the developer. An agitating-and-supplying member is rotatably provided in the developer storage portion. The agitating-and-supplying member has a shaft portion and an agitating portion. The agitating portion has a fixed end and a distal end opposite to each other. The fixed end of the agitating portion is fixed to the shaft portion. The agitating portion has an area corresponding to the opening. In the area, a distance between a center axis of the shaft portion and the distal end of the agitating portion is longer than a distance between the center axis of the shaft portion and an outer wall of the developer storage portion.

### BACKGROUND OF THE INVENTION

The present invention relates to a developer storage container for storing a developer, and relates to a developing device and an image forming apparatus using the developer storage container.

In a general electrophotographic printer, a surface of a photosensitive drum is uniformly charged by a charging device, and then exposed by an exposing device to form a latent image. The latent image is developed by a developing device to form a toner image. The toner image is transferred to a printing medium by a transfer unit, and is fixed to the printing medium by a fixing device.

As the developing device repeatedly performs the developing process, the amount of a toner (i.e., a developer) in the developing device decreases. Therefore, the developing device has a toner cartridge detachably mounted to a main body of the developing device. When the toner stored in the developing device is used up, the toner cartridge is replaced with new one, so as to replenish the toner to the developing device.

The toner cartridge has a toner supplying opening (i.e., a developer supplying opening) through which the toner is supplied to a toner hopper in the main body of the developing device. The toner supplying opening is formed to be relatively small (particularly, with respective to a length of the toner cartridge), in order to prevent decrease in rigidity of the toner cartridge, to prevent leakage of the toner, and to prevent scattering of the toner during a replacement operation of the toner cartridge.

The main body of the developing device has a toner receiving opening through which the toner is supplied to the toner hopper. The toner receiving opening is provided in a partial area in the longitudinal direction of the developing device, corresponding to the toner supplying opening of the toner cartridge. The developing device has an agitating-and-conveying unit provided in the toner hopper, which agitates and conveys the toner throughout a length of the developing device (see, Japanese Laid-open Patent Publication No. 2007-264165).

Recently, there is a need for a technique capable of effectively preventing a stagnation of a developer supplied via a developer supplying opening.

### SUMMARY OF THE INVENTION

The present invention is intended to provide a developer storage container, a developing device and an image forming apparatus capable of effectively preventing a stagnation of a developer supplied via an opening of the developer storage container.

The present invention provides a developer storage container including a developer storage portion that stores a developer and has an opening for supplying the developer. An agitating-and-supplying member is rotatably provided in the developer storage portion. The agitating-and-supplying member has a shaft portion and an agitating portion. The agitating portion has a fixed end and a distal end opposite to each other. The fixed end of the agitating portion is fixed to the shaft portion. The agitating portion has an area corresponding to the opening. In the area, a distance between a center axis of the shaft portion and the distal end of the agitating portion is longer than a distance between the center axis of the shaft portion and an outer wall of the developer storage portion.

With such a configuration, it becomes possible to prevent a stagnation of the developer supplied via the opening of the developer storage container.

The present invention also provides a developing device including the above described developer storage container.

The present invention also provides an image forming apparatus including the above described developer storage container.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic view showing a configuration of an image forming apparatus according to the first embodiment;

FIG. 2 is a cross sectional view showing a developing unit and a toner cartridge according to the first embodiment;

FIG. 3 is a bottom perspective view showing the toner cartridge according to the first embodiment;

FIG. 4 is a bottom perspective view showing the toner cartridge according to the first embodiment;

FIG. 5 is a perspective view showing an agitating-and-supplying member provided in the toner cartridge according to the first embodiment;

FIG. 6 is a bottom view showing the agitating-and-supplying member provided in the toner cartridge according to the first embodiment;

FIG. 7 is a front view showing the agitating-and-supplying member according to the first embodiment;

FIG. 8 is a longitudinal sectional view showing the toner cartridge according to the first embodiment, taken along line VIII-VIII in FIG. 2;

FIG. 9 is a bottom perspective view showing the toner cartridge according to the first embodiment;

FIG. 10 is a cross sectional view for illustrating an operation of the toner cartridge mounted to the developing unit according to the first embodiment;

FIG. 11 is a perspective view showing an agitating-and-supplying member according to the second embodiment;

FIG. 12 is a front view showing the agitating-and-supplying member according to the second embodiment;

FIG. 13 is a cross sectional view showing a toner cartridge and a developing unit according to the second embodiment, taken along line VIII-VIII in FIG. 2;

FIG. 14 is a perspective view showing an agitating-and-supplying member according to the third embodiment;

FIG. 15 is a bottom view showing the agitating-and-supplying member according to the third embodiment;

FIG. 16 is a front view showing the agitating-and-supplying member according to the third embodiment;

FIG. 17 is a longitudinal sectional view showing a toner cartridge according to the third embodiment, taken along line VIII-VIII in FIG. 2;

FIG. 18 is a bottom perspective view showing a toner supplying opening shutter and an agitating portion according to the fourth embodiment, and

FIG. 19 is a bottom view showing a toner ejection opening according to the fourth embodiment.

### DETAILED DESCRIPTION OF THE PREFERRED EMBODIMENT

Hereinafter, embodiments of the present invention will be described with reference to drawings.

### FIRST EMBODIMENT

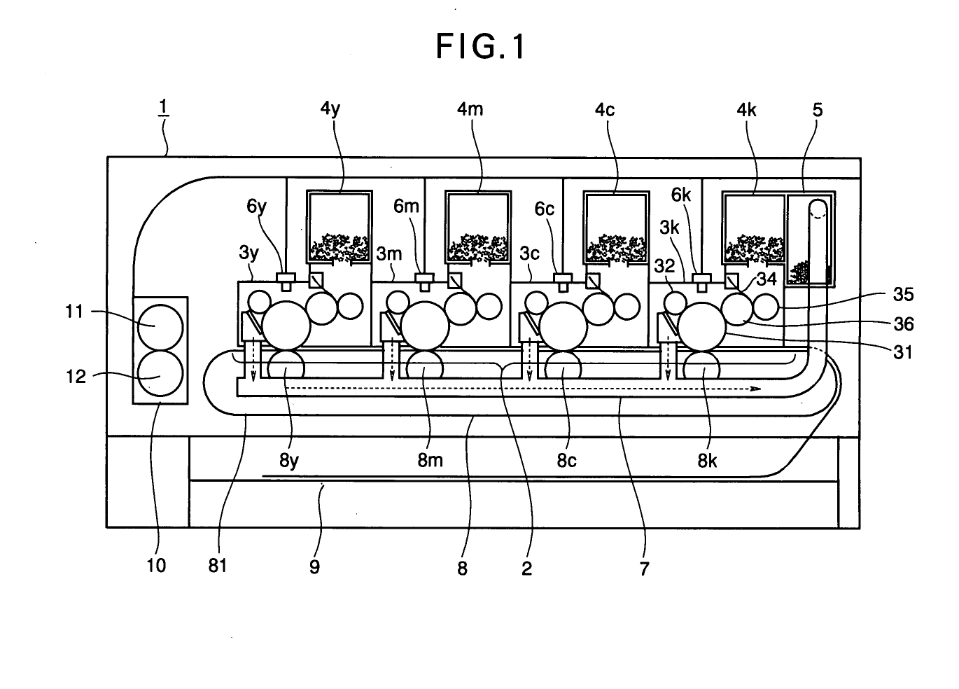

FIG. 1 is a schematic view showing a configuration of an image forming apparatus 1 according to the first embodiment of the present invention. As shown in FIG. 1, the image forming apparatus 1 includes a developing device 2, exposing units 6k, 6c, 6m and 6y, a transferring unit 8, a feeding cassette 9 and a fixing unit 10.

The developing device 2 includes developing units (also referred to as process units) 3k, 3c, 3m and 3y for forming toner images of black, cyan, magenta and yellow, and toner cartridges 4k, 4c, 4m and 4y respectively storing toners (developers) of black, cyan, magenta and yellow. The developing device 2 further includes a waste toner storage container 5 and a waste toner conveying unit 7.

The developing device 2 has an integral structure, and is detachably mounted to a main body of the image forming apparatus 1.

The developing units 3k, 3c, 3m and 3y are arranged along a medium feeding path in this order from an upstream side (i.e., a supply side) to a downstream side (i.e., an ejection side).

The toner cartridges 4k, 4c, 4m and 4y (as developer storage containers) are detachably mounted to the respective developing units 3k, 3c, 3m and 3y. The toner cartridges 4k, 4c, 4m and 4y stores toners of the respective colors, and supply the toners to the developing units 3k, 3c, 3m and 3y.

The waste toner storage container 5 collectively stores the waste toner ejected from the developing units 3k, 3c, 3m and 3y.

The exposing units 6k, 6c, 6m and 6y are provided so as to face photosensitive drums 31 (described later) of the developing units 3k, 3c, 3m and 3y. The exposing units 6k, 6c, 6m and 6y respectively expose the surfaces of the photosensitive drums 31 to form latent images. The exposing units 6k, 6c, 6m and 6y are constituted by LED heads in this embodiment, but the exposing units 6k, 6c, 6m and 6y are not-limited to LED heads.

The transfer unit 8 includes transfer rollers 8k, 8c, 8m and 8y provided so as to face the photosensitive drums 31 of the developing units 3k, 3c, 3m and 3y, and a transfer belt 81 passing between the respective photosensitive drums 31 and the transfer rollers 8k, 8c, 8m and 8y. The transfer unit 8 transfers toner images from the photosensitive drums 31 to a printing medium.

The feeding cassette 9 stores and feeds the printing media such as papers to the developing units 3k, 3c, 3m and 3y and the transfer unit 8.

The fixing unit 10 includes a fixing roller 11 and a pressure roller 12 which fix the toner image to the printing medium by application of heat and pressure.

Hereinafter, the developing units 3k, 3c, 3m and 3y will be collectively referred to as the developing units 3. The toner cartridges 4k, .4c, 4m and 4y will be collectively referred to as the toner cartridges 4. The exposing units 6k, 6c, 6m and 6y will be collectively referred to as the exposing units 6.

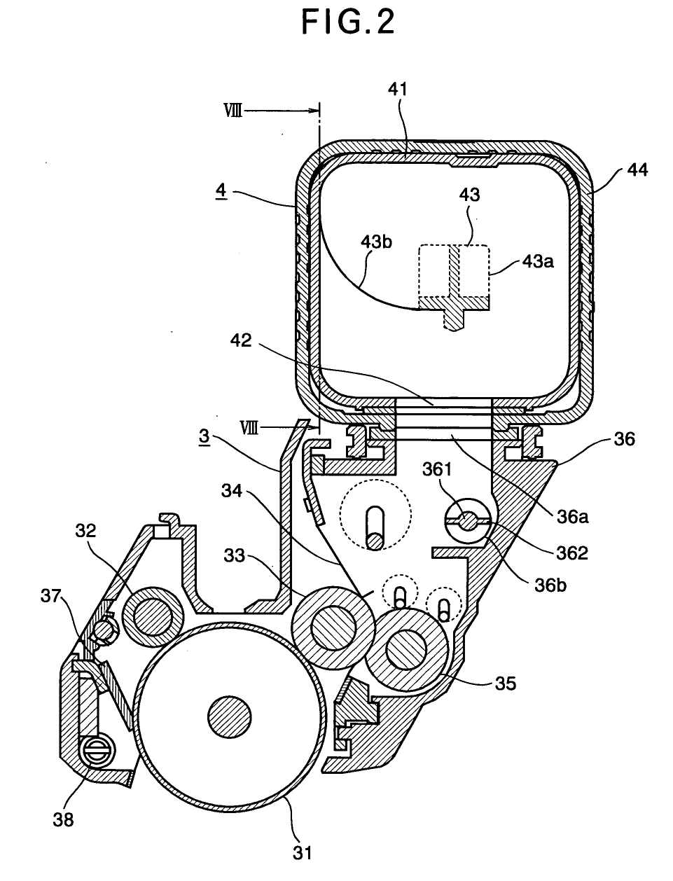

FIG. 2 is a cross sectional view showing the developing unit 3 and the toner cartridge 4 according to the first embodiment.

As shown in FIG. 2, the developing unit 3 (i.e., the process unit) includes a photosensitive drum 31 as an image bearing body, a charging roller 32 as a charging device, a developing roller 33 as a developer bearing body, a developing blade 34 as a developer regulating member, a supplying roller 35 as a developer supplying member, a toner hopper 36 as a developer reservoir, a cleaning blade 37 as a cleaning member and a removed-toner conveying unit 38.

The photosensitive drum 31 is an image bearing body on which a latent image is formed. The charging roller 32 uniformly charges the surface of the photosensitive drum 31. The developing roller 33 supplies the toner to the photosensitive drum 31 to develop the latent image on the photosensitive drum 31. The supplying roller 35 supplies the toner to the developing roller 33. The developing blade 34 regulates a thickness of a toner layer on the surface of the developing roller 33. The toner hopper 36 stores the toner supplied by the toner cartridge 4.

The toner hopper 36 has a toner receiving opening 36a (as a developer receiving opening) and a feeding spiral 36b (as a developer distributing member).

The toner receiving opening 36a is formed on a top of the toner hopper 36. The toner receiving opening 36a is located at a position corresponding to a toner supplying opening 42 (described later) of the toner cartridge 4. In this embodiment, the toner receiving opening 36a is formed on a partial area of the toner hopper 36 in the longitudinal direction of the toner hopper 36 (i.e., parallel to an axial direction of the photosensitive drum 31). Further, in the longitudinal direction of the toner hopper 36, a length of the toner receiving opening 36a is shorter than the length of the toner hopper 36.

The feeding spiral 36b has a shaft portion 361 whose center axis extends in the longitudinal direction of the toner hopper 36, and a spiral blade 362 protruding from the shaft portion 361 in a direction crossing a longitudinal direction of the shaft portion 361. By the rotation of the feeding spiral 36b, the toner supplied into the toner hopper 36 (via the toner receiving opening 36a) is conveyed in the longitudinal direction of the toner hopper 36 along a surface of the spiral blade 362 of the feeding spiral 36b. The feeding spiral 36b (below the toner receiving portion 36a) is preferably disposed on a position shifted to a front side (i.e., a downstream side) with respect to a center of the toner receiving portion 36a in a rotating direction of an agitating-and-supplying member 43 (described later) of the toner cartridge 4.

The cleaning blade 37 is configured to remove a residual toner that is not transferred to the printing medium but remains on the surface of the photosensitive drum 31. The removed-toner conveying unit 38 conveys the toner removed by the cleaning blade 37 toward the waste toner conveying unit 7 shown in FIG. 1.

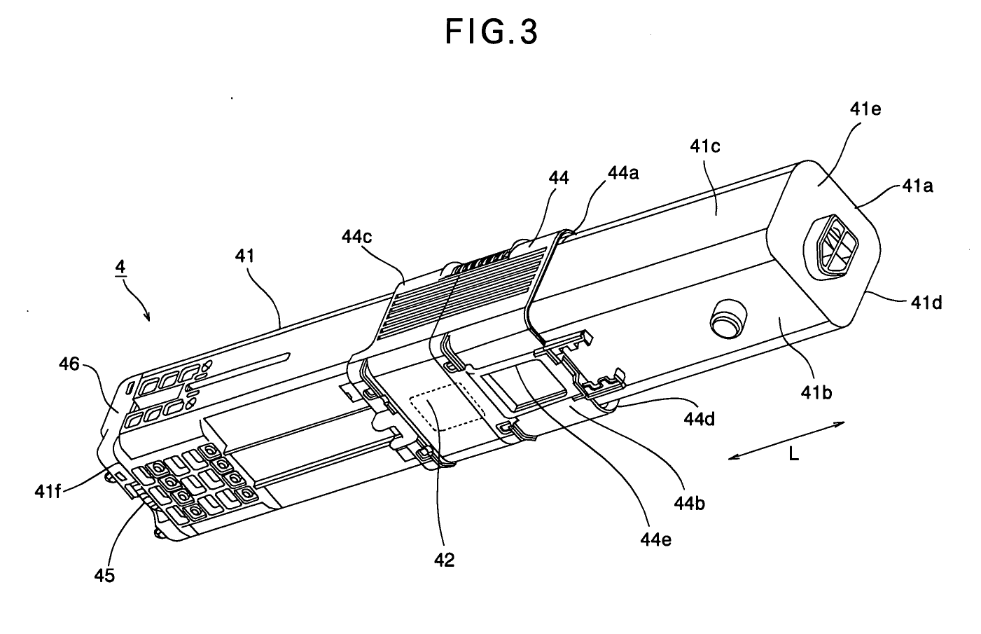

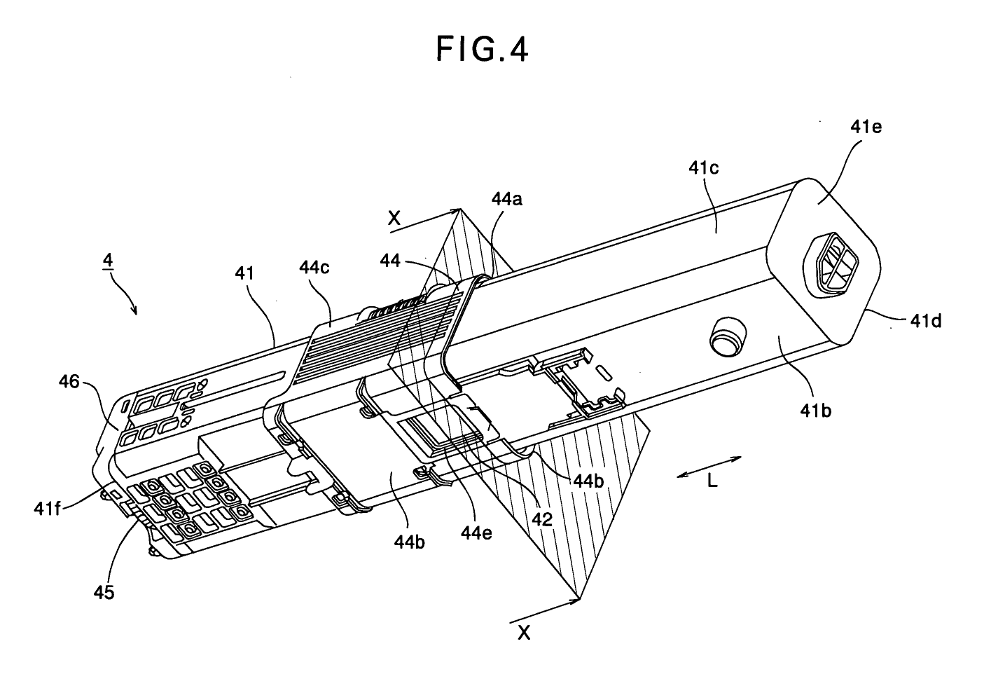

FIGS. 3 and 4 are bottom perspective views showing the toner cartridge 4.

As shown in FIGS. 3 and 4, the toner cartridge 4 includes an outer frame 41 (as a developer storage portion) with a toner supplying opening 42 (as an opening), an agitating-and-supplying member 43, and a toner supplying opening shutter 44 (as a shutter).

The outer frame 41 has a box shape as shown in FIGS. 3 and 4, and stores the toner therein.

The toner supplying opening 42 is formed on the bottom of the outer frame 41. In this embodiment, the toner supplying opening 42 is formed on a partial area of the outer frame 41 in a longitudinal direction of the outer frame 41. Further, in the longitudinal direction of the outer frame 41 (indicated by an arrow L in FIGS. 3 and 4), a length of the toner supplying opening 42 is shorter than a length of the outer frame 41. In this embodiment, the toner supplying opening 42 is provided so as to encompass a center position of the outer frame 41 in the longitudinal direction.

The agitating-and-supplying member 43 (FIG. 2) is provided in the outer frame 41 so as to be rotatable about a center axis (i.e., a center line) parallel to the longitudinal direction of the outer frame 41.

The toner supplying opening shutter 44 is movable in the longitudinal direction (indicated by the arrow L) of the outer frame 41. The toner supplying opening shutter 44 is movable between a position shown in FIG. 3 where the toner supplying opening shutter 44 closes the toner supplying opening 42, and a position shown in FIG. 4 where the toner supplying opening shutter 44 opens the toner supplying opening 42.

The toner cartridge 4 includes the outer frame 41 and the toner supplying opening shutter 44 as described above, and further includes an agitating-and-supplying member driving gear 45 and a side cover 46.

The outer frame 41 is in the form of a rectangular column having a top wall 41a, a bottom wall 41b, a first side wall 41c, a second side wall 41d, a third side wall 41e and a fourth side wall 41f. The walls 41a through 41f surround a space for storing the toner therein.

In this embodiment, the outer frame 41 is in the form of the rectangular column. However, the outer frame 41 can be in the form of, for example, a circular cylinder or a polygonal column such as a triangular column.

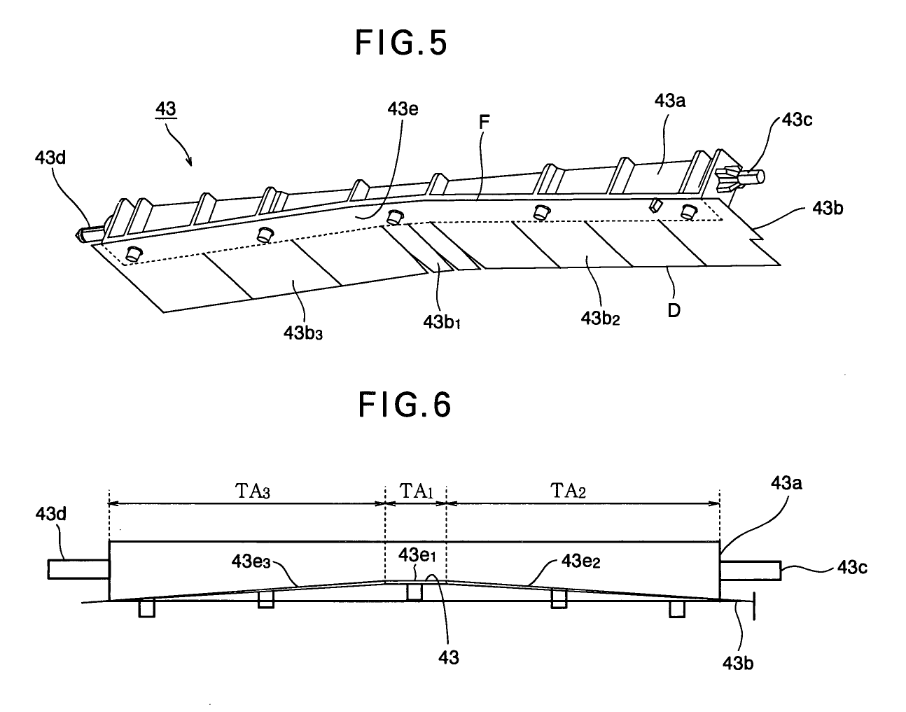

Shaft-holes (not shown) are formed on inner sides of the third wall 41e and the fourth wall 41f which are disposed on both ends of the outer frame 41 in the longitudinal direction. End portions (i.e., pins 43c and 43d shown in FIG. 5) of a shaft portion of the agitating-and-supplying member 43 engage and are supported by the shaft-holes.

The toner supplying opening 42 is formed on the bottom wall 41b of the outer frame 41. The toner supplying opening 42 is located on a partial area in the longitudinal direction of the outer frame 41. The toner supplying opening 42 has a rectangular shape. Two longer edges of the toner supplying opening 42 are parallel to longer edges of the bottom wall 41b (i.e., parallel to the longitudinal direction of the outer frame 41).

The toner supplying opening shutter 44 includes a top wall 44a, a bottom wall 44b, a first side wall 44c and a second side wall 44d. The top wall 44a, the bottom wall 44b, the first side wall 44c and the second side wall 44d surround the outer frame 41. That is, an inner surface of the top wall 44a faces an outer surface of the top wall 41a. An inner surface of the bottom wall 44b faces an outer surface of the bottom wall 41b. An inner surface of the first side wall 44c faces an outer surface of the first side wall 41c. An inner surface of the second side wall 44d faces an outer surface of the second side wall 41d. The toner supplying opening shutter 44 has two opened ends in the longitudinal direction of the outer frame 41, and the toner supplying opening shutter 44 is movable in the longitudinal direction of the outer frame 41 (i.e., in the direction indicated by the arrow L).

A toner ejection opening 44e (as an ejection opening) is formed on the bottom wall 44b of the toner supplying opening shutter 44. The toner ejection opening 44e has substantially the same shape as the toner supplying opening 42. When the toner supplying opening shutter 44 is moved in the longitudinal direction of the outer frame 41 as shown in FIG. 4, the toner ejection opening 44e faces the toner supplying opening 42, so that the toner stored in the outer frame 41 is ejected outside (i.e., to the toner hopper 36). In contrast, when the toner supplying opening shutter 44 is moved in the longitudinal direction of the outer frame 41 as shown in FIG. 3, the toner ejection opening 44e does not face the toner supplying opening 42 (instead, the toner ejection opening 44e faces the bottom wall 44b), so that an inner space of the outer frame 41 is closed.

The agitating-and-supplying member driving gear 45 is provided on the fourth side wall 41f disposed on the end of the outer frame 41 in the longitudinal direction. The agitating-and-supplying member driving gear 45 transmits a rotation of a driving unit (not shown) provided on the developing unit 3 to the agitating-and-supplying member 43 in the outer frame 41.

The side cover 46 is formed on the fourth side wall 41f so as to cover the agitating-and-supplying member driving gear 45.

In order to prevent leakage of the toner, seal members such as sponges are provided on a gap between the toner supplying opening 42 and the bottom wall 44b of the toner supplying opening shutter 44, and a gap between the pins 43c and 43d (FIG. 5) of the agitating-and-supplying member 43 and the shaft-holes (not shown) of the third and fourth side walls 41e and 41f.

FIG. 5 is a perspective view showing the agitating-and-supplying member 43 provided in the toner cartridge 4. As shown in FIG. 5, the agitating-and-supplying member 43 has a shaft portion 43a and an agitating portion 43b.

The shaft portion 43a extends linearly, and has first and second pins (i.e., supporting pins) 43c and 43d provided on both ends in the longitudinal direction. The pins 43c and 43d are inserted into the shaft-holes (not shown) formed on the inner sides of the third and fourth side walls 41e and 41f of the outer frame 41, so that the shaft portion 43a is supported so as to be rotatable about a center axis of the shaft portion 43a.

The shaft portion 43a has a mounting surface 43e extending along the center axis of the shaft portion 43a. FIG. 6 is a bottom view of the agitating-and-supplying member 43. As shown in FIG. 6, the mounting surface 43e has a first area TA₁ at a center in the longitudinal direction, and second and third areas TA₂ and TA₃ on both sides of the first area TA₁. The second area TA₂ is disposed on the first pin 43c, and the third area TA₃ is disposed on the second pin 43d.

The mounting surface 43e₁ of the first area TA₁ is a surface whose normal line is perpendicular to the center axis of the shaft portion 43a. The mounting surface 43e₂ of the second area TA₂ is inclined so that a distance from the center axis of the shaft portion 43a increases toward the first pin 43c side. The mounting surface 43e₃ of the third area TA₃ is inclined so that a distance from the center axis of the shaft portion 43a increases toward the second pin 43d side.

An angle between the mounting surface 43e₁ of the first area TA₁ and the mounting surface 43e₂ of the second area TA₂, and an angle between the mounting surface 43e₁ of the first area TA₁ and the mounting surface 43e₃ of the third area TA₃ can be arbitrarily determined so as to cause the toner to move from the agitating portion 43b₂ fixed to the mounting surface 43e₂ and the agitating portion 43b₃ fixed to the mounting surface 43e₃ toward the agitating portion 43b₁ fixed to the mounting surface 43e₁ as described later. A length of the mounting surface 43e₁ of the first area TA₁ is shorter than the toner supplying opening 42 of the outer frame 41 in the longitudinal direction of the outer frame 41.

The agitating portion 43b is fixed to the mounting surface 43e via a fixing means such as an adhesive agent.

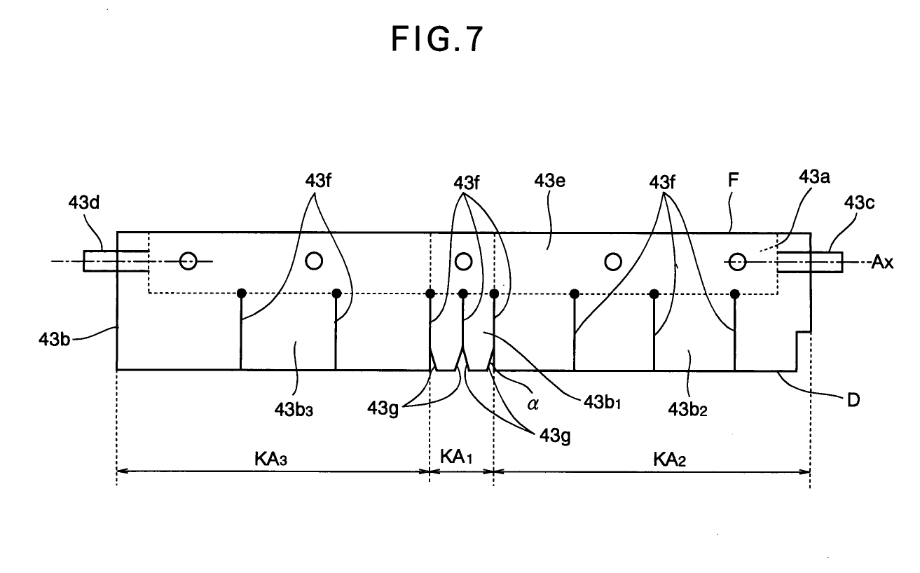

FIG. 7 is a front view of the agitating portion 43b. The agitating portion 43b has a substantially rectangular shape elongated along the shaft portion 43a. One of longer edges of the agitating portion 43b is fixed to the mounting surface 43e of the shaft portion 43a. Hereinafter, the longer edge of the agitating portion 43b fixed to the mounting surface 43e will be referred to as a fixed longer edge F (also referred to as a fixed end).

The agitating portion 43b is formed of a resilient member such as a film member. For example, the agitating portion 43b is formed by bending a resilient member (for example, a film) having a flat shape. In this case, the resilient member is going to recover its original flat shape, so that a resilient force is generated. The agitating portion 43b can be formed of a material that generates a resilient force as described later. In this embodiment, the agitating portion 43b is formed of polyethylene terephthalate (PET).

The thickness of the agitating portion 43b is preferably in a range from 0.05 mm to 0.15 mm for generating a necessary resilient force. The most preferable thickness of the agitating portion 43b is preferably 0.10 mm.

In the longitudinal direction of the outer frame 41, the length of the agitating portion 43b (fixed to the mounting surface 43e) is shorter than a distance between the inner surfaces of the third side wall 41e and the fourth side wall 41f of the outer frame 41.

When the agitating portion 43b is held in a flat shape as shown in FIG. 7, a distance between the center axis (indicated by a mark “Ax”) of the shaft portion 43a and a longer edge of the agitating portion 43b farthest from the shaft portion 43a is longer than a maximum distance between the center axis of the shaft portion 43a and the inner surface of the outer frame 41.

Therefore, in a state where the agitating-and-supplying member 43 is mounted in the outer frame 41, the agitating portion 43b contacts the inner surface of the outer frame 41 in a deflected manner. Hereinafter, the longer edge of the agitating portion 43b farthest from the shaft portion 43a will be referred to as a distal longer edge D (also referred to as a distal end).

The agitating portion 43b has a plurality of slits 43f extending from the distal longer edge D toward the fixed longer edge L of the agitating portion 43b.

The agitating portion 43b has a first area KA₁, a second area KA₂ and a third area KA₃ corresponding to the first area TA₁, the second area TA₂ and the third area TA₃ of the mounting surface 43e of the shaft portion 43a. These areas KA₁, KA₂ and KA₃ are separated by slits 43f. It is also possible to form additional slit(s) 43f within the areas KA₁, KA₂ and KA₃, in addition to the slits 43f separating the areas KA₁, KA₂ and KA₃. The numbers of the slits 43f within the areas KA₁, KA₂ and KA₃ can be arbitrarily determined.

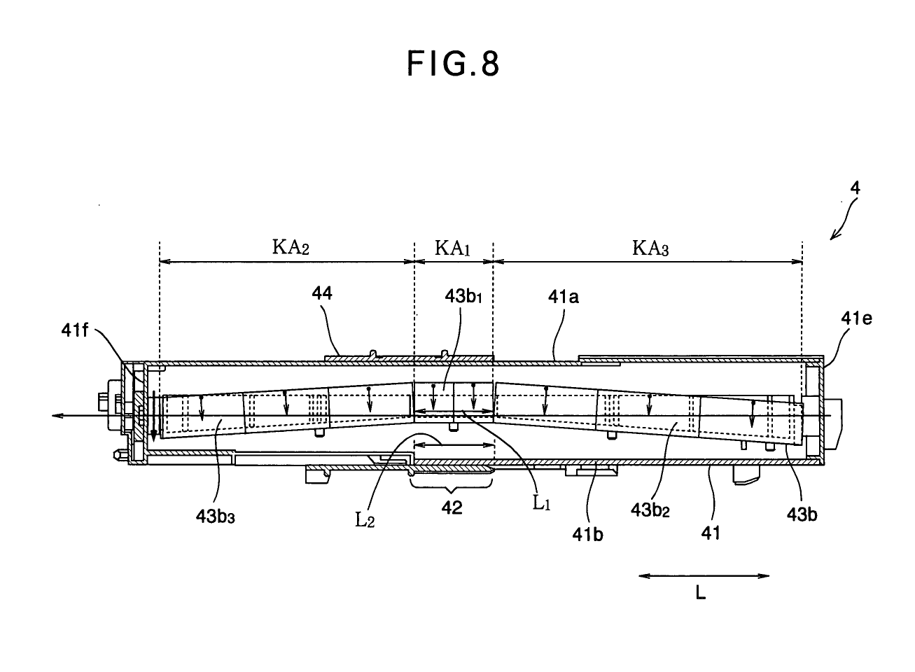

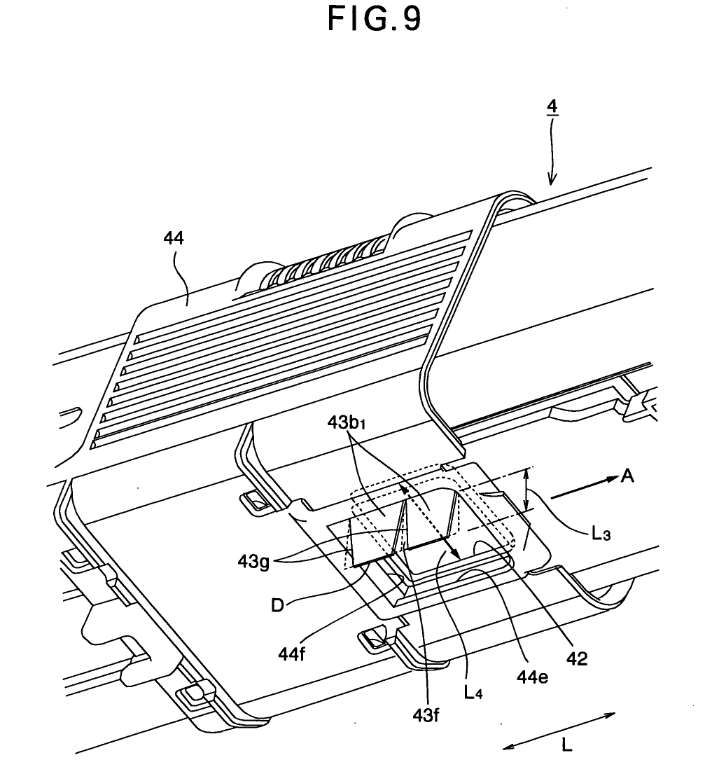

FIG. 8 is a longitudinal sectional view of the toner cartridge 4, taken along line VIII-VIII in FIG. 2. FIG. 9 is a bottom perspective view of the toner cartridge 4. As shown in FIG. 8, a length L1 of the agitating portion 43b₁ of the first area KA₁ in the longitudinal direction is shorter than or equal to a length L2 of the toner supplying opening 42 of the outer frame 41 in the longitudinal direction of the outer frame 41.

Therefore, as shown in FIG. 9, when the agitating portion 43b₁ of the first area KA₁ is in a position facing the toner supplying opening 42 of the outer frame 41, the agitating portion 43b₁ of the first area KA₁ protrudes outside the outer frame 41 via the toner supplying opening 42. Further, if the agitating portion 43b₁ has a suitable width (i.e. a dimension perpendicular to the center axis of the shaft portion 43a), the agitating portion 43b₁ of the first area KA₁ (protruding outside the outer frame 41 via the toner supplying opening 42) intrudes into the toner hopper 36 disposed below the toner supplying opening 42, and pushes the toner in the toner hopper 36 (more specifically, in the vicinity of the toner receiving opening 36a) toward the feeding spiral 36b.

As described above, the width of the agitating portion 43b in a direction perpendicular to the center axis of the shaft portion 43a is determined so that the distance between the center axis of the shaft portion 43a and the distal longer edge D of the agitating portion 43b is longer than the maximum distance between the center axis of the shaft portion 43a and the inner surface of the outer frame 41. Further, the distance between the center axis of the shaft portion 43a and the distal longer edge D of the agitating portion 43b is longer than a distance between the center axis of the shaft portion 43a and the outer surface of the outer frame 41. More preferably, the distance between the center axis of the shaft portion 43a and the distal longer edge D of the agitating portion 43b is longer than a distance between the center axis of the shaft portion 43a and the toner receiving opening 36a of the toner hopper 36.

The distance between the center axis of the shaft portion 43a and the distal longer edge D of the agitating portion 43b has an upper limit so that the agitating portion 43b does not contact a device provided in the toner hopper 36 such as the feeding spiral 36.

Referring back to FIG. 7, the slits 43f of the agitating portion 43b have lengths so as to extend from the distal longer edge D to reach the mounting surface 43. However, the lengths of the slits 43f can be arbitrarily determined.

At least one of both sides of the agitating portion 43b₁ of the first area KA₁ has an inclined portion 43g so that a length of the agitating portion 43b₁ of the first area KA₁ (in a direction of the center axis of the shaft portion 43a) decreases toward the distal longer edge D. In other words, the length of the agitating portion 43b₁ of the first area KA₁ in the direction of the center axis of the shaft portion 43a is shorter at the distal longer edge D than at the fixed longer edge F.

In this embodiment, the agitating portion 43b₁ of the first area KA₁ is divided into two sections by the slit 43f. Each section of the agitating portion 43b₁ of the first area KA₁ has inclined portions 43g on both sides.

The inclined portion 43g is inclined at an angle α with respect to a widthwise direction of the agitating portion 43 (i.e., a direction perpendicular to the center axis of the shaft portion 43a). The angle α is preferably in a range from 10 to 45 degrees, and more preferably in a range from 20 to 30 degrees.

With the provision of the inclined portions 43g, when the toner supplying opening shutter 44 is moved in a direction indicated by an arrow A to close the toner supplying opening 42 (in a state where the agitating portion 43b₁ of the first area KA₁ protrudes outside via the toner supplying opening 42), an inner periphery 44f of the toner supplying opening 42 on a rear side in the moving direction A contacts the inclined portion 43g of the agitating portion 43b₁ of the first area KA₁, and pushes the agitating portion 43b₁ upward into the toner cartridge 4.

In order to smoothly push the agitating portion 43b₁ of the first area KA₁ into the toner cartridge 4, it is necessary that a length L3 of the agitating portion 43b₁ of the first area KA₁ protruding outside the outer frame 41 is shorter than a width L4 (FIG. 9) of the toner supplying opening 42 in the widthwise direction of the toner cartridge 4.

In this embodiment, the agitating portion 43b₁ of the first area KA₁ has inclined portions 43g on both sides (i.e., on the sides facing the second area KA₂ and facing the third area KA₃) as shown in FIG. 7. However, it is only necessary that the agitating portion 43b₁ of the first area KA₁ has the inclined portion 43f on the side facing the third area KA₃ (i.e., the side that contacts the inner periphery 44f of the toner supplying opening 42).

In this regard, a length of the inclined portion 43f in the direction perpendicular to the center axis of the shaft portion 43a is longer than a length by which the agitating portion 43b₁ of the first area KA₁ protrudes outside the outer frame 41 via the toner ejection opening 44e.

As described above, the mounting surface 43e₁ of the first area TA₁ is a surface whose normal line is perpendicular to the center axis of the shaft portion 43a. The mounting surface 43e₂ of the second area TA₂ is inclined so that a distance from the center axis of the shaft portion 43a increases toward the first pin 43c. The mounting surface 43e₃ of the third area TA₃ is inclined so that a distance from the center axis of the shaft portion 43a increases toward the second pin 43d. Further, the agitating portion 43b has the first area KA₁, the second area KA₂ and the third area KA₃ respectively corresponding to the first area TA₁, the second area TA₂ and the third area TA₃ of the mounting surface 43e.

With such a configuration, as shown in FIG. 8, the agitating portion 43b₂ of the second area KA₂ and the agitating portion 43b₃ of the third area KA₃ are inclined toward the agitating portion 43b₁ of the first area KA₁. Therefore, when the shaft portion 43a rotates about the center axis, the toner is pushed by the agitating portion 43b₂ of the second area KA₂ and the agitating portion 43b₃ of the third area KA₃ and moves toward the agitating portion 43b₁ of the first area KA₁. Thus, the toner is collected at the first area KA₁, and is supplied to outside via the toner supplying opening 42 (disposed on a position corresponding to the first area KA₁).

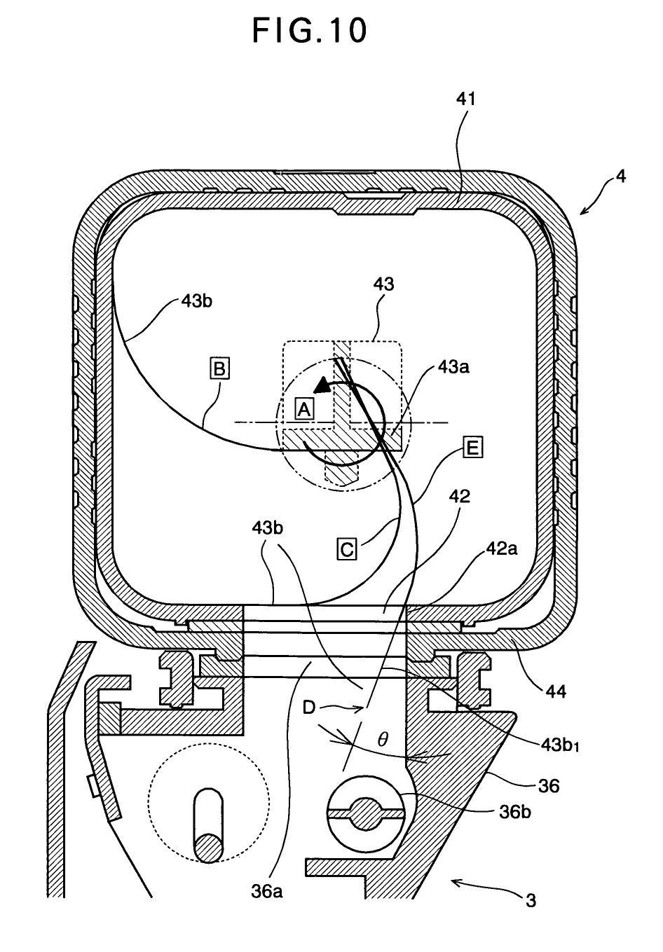

An operation of the toner cartridge 4 mounted to the developing unit 3 will be described with reference to FIG. 10.

FIG. 10 is a cross sectional view for illustrating the operation of the toner cartridge 4 mounted to the developing unit 3, taken along line X-X in FIG. 4. In FIG. 10, reference marks B, C and E indicate respective states of the agitating portion 43b as the agitating-and-supplying member 43 rotates in the direction indicated by the arrow A about the center axis of the shaft portion 43a.

First, as the agitating-and-supplying member 43 rotates in the direction indicated by the arrow A about the center axis, the agitating portion 43b (of the areas KA₁, KA₂ and KA₃) contacts the inner surface of the outer frame 41 in such a manner that the agitating portion 43b is deflected as indicated by a reference mark “B”. A deflecting direction of the agitating portion 43b is opposite to the rotating direction of the agitating-and-supplying member 43. With this rotation, the agitating-and-supplying member 43 conveys the toner (stored in the outer frame 41) in the rotating direction indicated by the arrow A.

In this regard, if a large amount of the toner is stored in the outer frame 41, there may be cases where the agitating portion 43b does not contacts the inner surface of the outer frame 41.

As the agitating-and-supplying member 43 further rotates in the direction indicated by the arrow A about the center axis, a tip (i.e., the distal longer end D) of the agitating portion 43b₁ of the first area KA₁ reaches the toner supplying opening 42 of the outer frame 41 as indicated by a reference mark “C” in FIG. 10. Further, due to the resilient force of the agitating portion 43b₁, the agitating portion 43b₁ of the first area KA₁ instantly changes its shape as indicated by a reference mark “E” in FIG. 10.

In this state, the tip of the agitating portion 43b₁ of the first area KA₁ becomes free from contact with the inner surface of the outer frame 41.

As the agitating portion 43b₁ of the first area KA₁ changes its shape as indicated by the reference mark “E” to release its deflection, the agitating portion 43b₁ pushes the toner into the toner hopper 36. Further, the agitating portion 43b₁ disperses the toner stagnating in the vicinity of the toner receiving opening 36a of the toner hopper 36, and pushes the toner into the toner hopper 36 (to be more specific, toward the feeding spiral 36b).

When the agitating portion 43b₁ of the first area KA₁ is in a state shown by the reference mark “E”, the agitating portion 43b₁ contacts an inner periphery 42a of the toner supplying opening 42. The tip (i.e., the distal longer edge D) of the agitating portion 43b₁ positions at a rear side with respect to the inner periphery 42a of the toner supplying opening 42 in a rotating direction of the agitating-and-supplying member 43. An angle θ (which is greater than 0) is formed between the agitating portion 43b₁ and the inner periphery 42a of the toner supplying opening 42. When the toner supplying opening shutter 44 is moved to close the toner supply opening 42 in a state where the agitating portion 43b₁ protrudes outside the outer frame 41, the toner supplying opening shutter 44 pushes the inclined portion 43g of the agitating portion 43b₁ of the first area KA₁, so that the agitating portion 43b₁ of the first area KA₁ is pushed into the outer frame 41. Thus, the agitating portion 43b is not nipped by the toner supplying opening shutter 44 and the outer frame 41.

When the agitating-and-supplying member 43 further rotates in the direction indicated by the arrow A from the state indicated by the reference mark “E”, the agitating portion 43b₁ of the first area KA₁ is deflected in a direction to increase its deflection, and is retracted inside the outer frame 41.

As described above, according to the first embodiment, the agitating portion 43b of the agitating-and-supplying member 43 protrudes outside the toner cartridge 4 and intrudes into the toner hopper 36 via the toner supplying opening 42, and therefore the stagnation of the toner in the toner hopper 36 (more specifically, in the vicinity of the toner receiving opening 36a) can be prevented.

### SECOND EMBODIMENT

Next, the second embodiment of the present invention will be described. The second embodiment is different from the first embodiment in the structure of the agitating-and-supplying member 43 (243). Hereinafter, an agitating-and-supplying member 243 according to the second embodiment and its related components will be described.

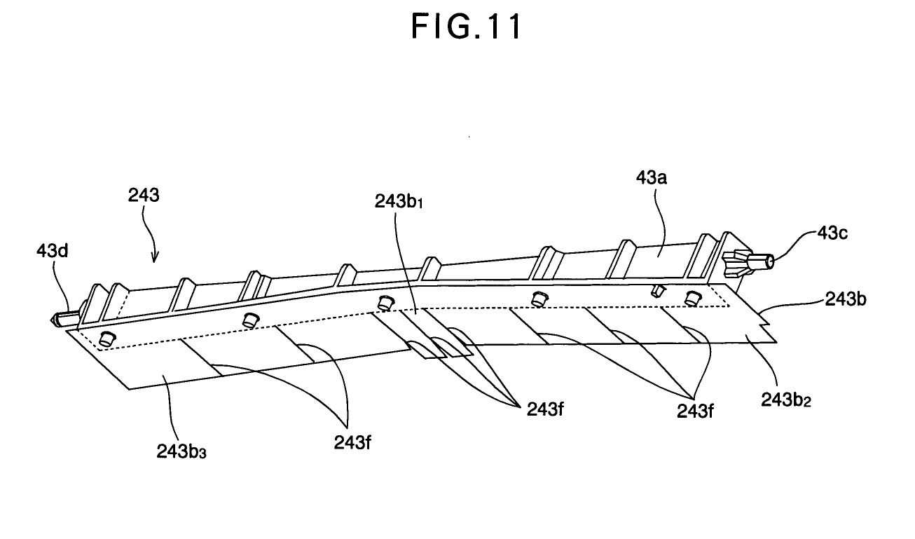

FIG. 11 is a perspective view showing the agitating-and-supplying member 243 of the second embodiment of the present invention. As shown in FIG. 11, the agitating-and-supplying member 243 includes a shaft portion 43a and an agitating portion 243b. The shaft portion 43a is the same as that of the first embodiment, but the agitating portion 243b is different from the agitating portion 43b of the first embodiment. Therefore, a structure of the agitating portion 243b will be described.

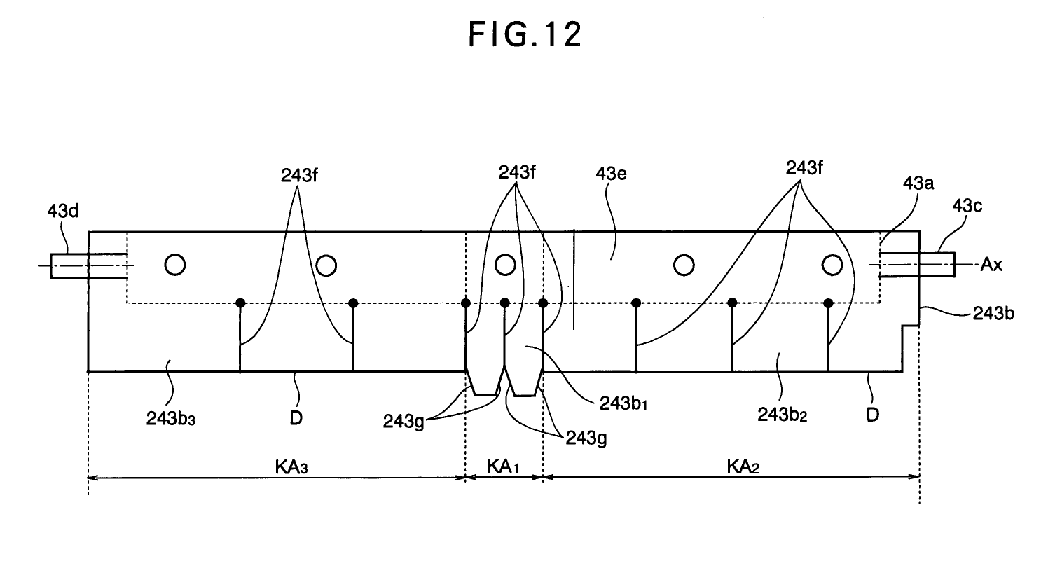

FIG. 12 is a front view of the agitating portion 243b. As shown in FIG. 12, a longitudinal direction of the agitating portion 243b is parallel to the center axis of the shaft portion 43a. An end of the agitating portion 243b in a direction perpendicular to the center axis of the shaft portion 43a (i.e., a fixed longer edge F) is fixed to the mounting surface 43e of the shaft portion 43a as in the first embodiment. Another longer edge of the agitating portion 243b (opposite to the fixed longer edge F) will be referred to as a distal longer edge D.

The agitating portion 243b has the first area KA₁, the second area KA₂ and the third area KA₃ separated by slits 243f as described in the first embodiment. A width of the agitating portion 243b₁ of the first area KA₁ (in the direction perpendicular to the center axis of the shaft portion 43a) is the same as that of the first embodiment. In contrast, the widths (in the direction perpendicular to the center axis of the shaft portion 43a) of the agitating portion 243b₂ of the second area KA₂ and the agitating portion 243b₃ of the third area KA₃ are shorter than those of the first embodiment.

In this regard, in a state where the agitating portion 243 is held in a flat shape as shown in FIG. 12, a distance between the center axis (Ax) of the shaft portion 43a and the distal longer edge D of the agitating portion 243b₂ of the second area KA₂ is longer than a maximum distance between the center axis of the shaft portion 43a and the inner surface of the outer frame 41. Further, a distance between the center axis (Ax) of the shaft portion 43a and the distal longer edge D of the agitating portion 243b₃ of the third area KA₃ is longer than the maximum distance between the center axis of the shaft portion 43a and the inner surface of the outer frame 41. That is, the agitating portion 243b₂ of the second area KA₂ and the agitating portion 243b₃ of the third area KA₃ both contact the inner surface of the outer frame 41.

When the agitating portion 243b rotates contacting the inner surface of the outer frame 41, deflection amounts of the agitating portion 243b₂ of the second area KA₂ and the agitating portion 243b₃ of the third area KA₃ are relatively small, since the agitating portion 243b₂ of the second area KA₂ and the agitating portion 243b₃ of the third area KA₃ are relatively short as described above. Therefore, the agitating portion 243b₂ of the second area KA₂ and the agitating portion 243b₃ of the third area KA₃ sweep the toner (stored in the outer frame 41) with a relatively small deflection, as compared with the agitating portion 43 of the first embodiment. Thus, the agitating portion 243b₂ of the second area KA₂ and the agitating portion 243b₃ of the third area KA₃ sweep the toner in a relatively upright manner, as compared with the agitating portion 43 of the first embodiment. As a result, the toner can efficiently be swept.

Further, even when the agitating portion 243b₂ of the second area KA₂ and the agitating portion 243b₃ of the third area KA₃ contact the inner surface of the outer frame 41, the agitating portion 243b₂ of the second area KA₂ and the agitating portion 243b₃ of the third area KA₃ can still be further deformed. Therefore, a resistance to the rotation of the agitating-and-supplying member 243 caused by the toner in the outer frame 41 is reduced by the deformation of the agitating portion 243b₂ of the second area KA₂ and the agitating portion 243b₃ of the third area KA₃, with the result that a rotational load of the agitating-and-supplying member 243 is reduced.

As described in the first embodiment, the length of the agitating portion 243b₁ of the first area KA₁ (in the longitudinal direction of the agitating portion 243b) is shorter than the length of the toner supplying opening 42 in the longitudinal direction of the outer frame 41, so that the agitating portion 243b₁ of the first area KA₁ can enter into the toner hopper 36.

Further, as described in the first embodiment, at least one of both sides of the agitating portion 243b₁ of the first area KA₁ has an inclined portion 243g so that a length of the agitating portion 243b₁ of the first area KA₁ (in the direction of the center axis of the shaft portion 43a) decreases toward the distal longer edge D. In other words, the length of the agitating portion 243b₁ of the first area KA₁ in the direction of the center axis of the shaft portion 43a is shorter at the distal longer edge D than at the fixed longer edge F.

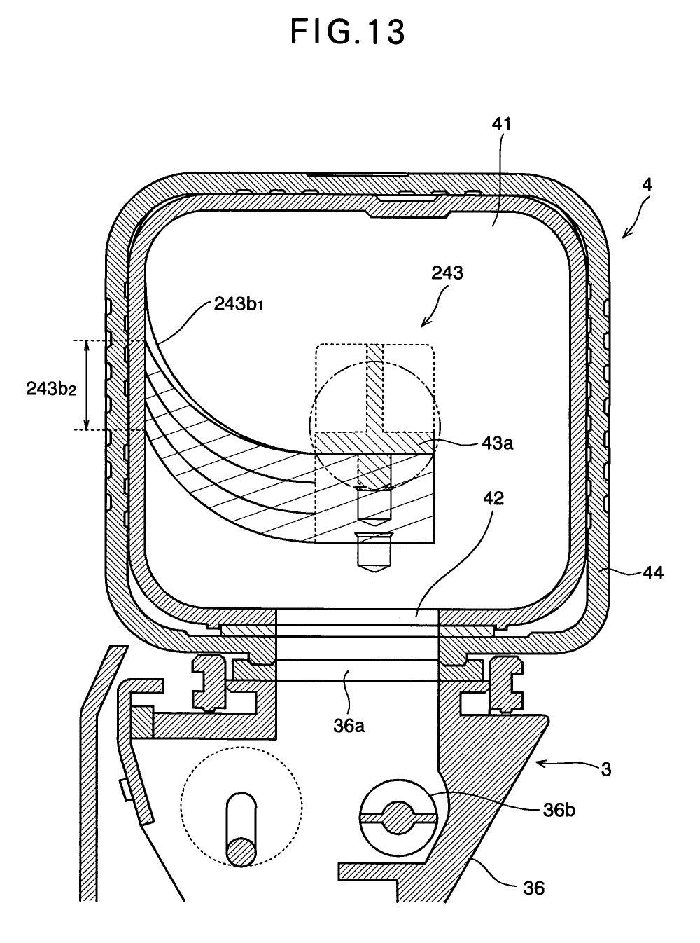

FIG. 13 is a cross sectional view showing the toner cartridge 4 mounted to the developing unit 3, corresponding to the cross section taken along line X-X in FIG. 4. As shown in FIG. 13, according to the second embodiment, the agitating portion 243b₂ of the second area KA₂ and the agitating portion 243b₃ of the third area KA₃ are less deformed than the agitating portion 243b₁ of the first area KA₁ while sweeping the toner stored in the outer frame 41. That is, the agitating portion 243b₂ of the second area KA₂ and the agitating portion 243b₃ of the third area KA₃ sweep the toner in a relatively upright manner. Therefore, the toner can be efficiently swept. Further, since the agitating portion 243b₂ of the second area KA₂ and the agitating portion 243b₃ of the third area KA₃ can be further deformed even when the agitating portion 243b₂ of the second area KA₂ and the agitating portion 243b₃ of the third area KA₃ contact the inner surface of the outer frame 41, a resistance to the rotation of the agitating-and-supplying member 243 (caused by the toner) can be reduced, and a rotational load of the agitating-and-supplying member 243 is reduced.

### THIRD EMBODIMENT

Next, the third embodiment of the present invention will be described.

The third embodiment is different from the first embodiment in structure of the agitating-and-supplying member 43 (343). Hereinafter, an agitating-and-supplying member 343 of the third embodiment and its related components will be described.

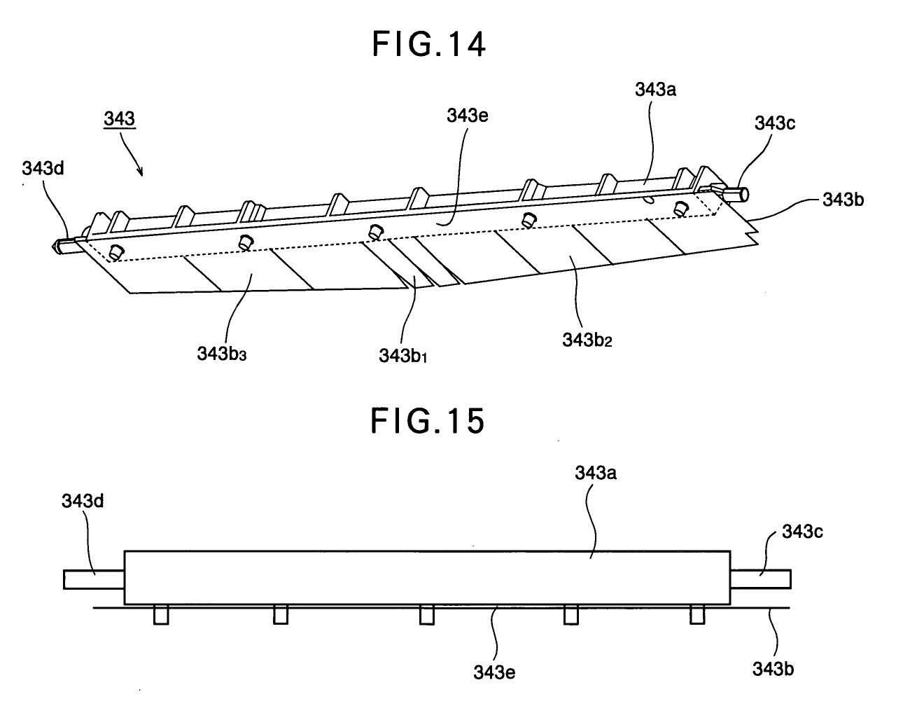

FIG. 14 is a perspective view showing the agitating-and-supplying member 343 according to the third embodiment of the present invention. As shown in FIG. 14, the agitating-and-supplying member 343 includes a shaft portion 343a and an agitating portion 343b. Hereinafter, differences between the agitating-and-supplying member 343 of the third embodiment and the agitating-and-supplying member 43 of the first embodiment will be described.

FIG. 15 is a bottom view of the agitating-and-supplying member 343. As shown in FIG. 15, the shaft portion 343a linearly extends, and has first and second pins 343c and 343d are provided on both ends in the longitudinal direction. The pins 343c and 343d (i.e., supporting pins) are inserted into the shaft-holes formed on the inner sides of the third side wall 41e and the fourth side wall 41f (see, FIG. 8) of the outer frame 41, so that the shaft portion 343a is rotatable about the center axis.

Referring back to FIG. 14, the shaft portion 343a has a mounting surface 343e extending in a direction of the center axis of the shaft portion 343a. Unlike the mounting surface 43e of the first embodiment, the mounting surface 343 is formed as a flat surface.

The agitating portion 343b is fixed to the mounting surface 343e using a fixing means such as an adhesive agent.

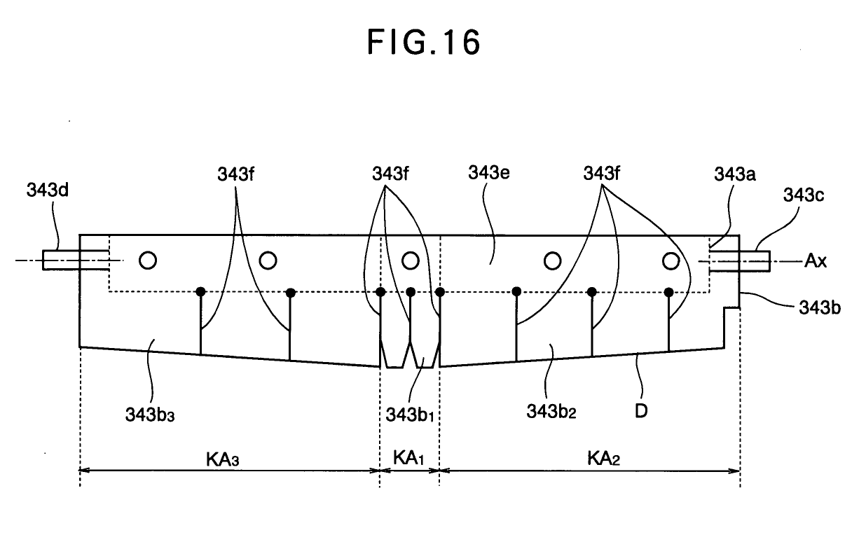

FIG. 16 is a front view of the agitating portion 343b. As shown in FIG. 16, a longitudinal direction of the agitating portion 343b is parallel to the center axis of the shaft portion 343a. An end of the agitating portion 343b in a direction perpendicular to the center axis of the shaft portion 343a (i.e., a fixed longer edge F) is fixed to the mounting surface 343e of the shaft portion 343a. Another longer edge of the agitating portion 343a (opposite to the fixed longer edge F) will be referred to as a distal longer edge D.

The shaft portion 343b has a first area KA₁, a second area KA₂ and a third area KA₃ separated by slits 343f as described in the first embodiment. A width of the agitating portion 343b₁ of the first area KA₁ (in the direction perpendicular to the center axis of the shaft portion 343a) is the same as that of the first embodiment. In contrast, a width of the agitating portion 343b₂ of the second area KA₂ gradually decreases toward the first pin 343c. Further, a width of the agitating portion 343b₃ of the third area KA₃ gradually decreases toward the second pin 343d. In other words, a distance between the center axis of the shaft portion 343a and the distal longer edge D of the agitating portion 343b₂ of the second area KA₂ gradually decreases toward the first pin 343c. A distance between the center axis of the shaft portion 343a and the distal longer edge D of the agitating portion 343b₃ of the third area KA₃ gradually decreases toward the second pin 343d.

In this regard, in a state where the agitating portion 343 is held in a flat shape as shown in FIG. 16, the distance between the center axis of the shaft portion 343a and the distal longer edge D of the agitating portion 343b₂ of the second area KA₂ is longer than a maximum distance between the center axis of the shaft portion 343a and the inner surface of the outer frame 41. Further, the distance between the center axis of the shaft portion 343a and the distal longer edge D of the agitating portion 343b₃ of the third area KA₃ is longer than the maximum distance between the center axis of the shaft portion 343a and the inner surface of the outer frame 41. That is, the agitating portion 343b₂ of the second area KA₂ and the agitating portion 343b₃ of the third area KA₃ both contact the inner surface of the outer frame 41.

With such a configuration, in a state where the agitating-and-supplying member 343 is mounted in the toner cartridge 4, the agitating portion 343b contacts the inner surface of the outer frame 41 in a deflected manner. Due to the above described widths of the agitating portion 343b₂ of the second area KA₂ and the agitating portion 343b₃ of the third area KA₃, the deflection amounts of the agitating portion 343b₂ of the second area KA₂ and the agitating portion 343b₃ of the third area KA₃ decrease toward either end of the agitating portion 343b in the longitudinal direction.

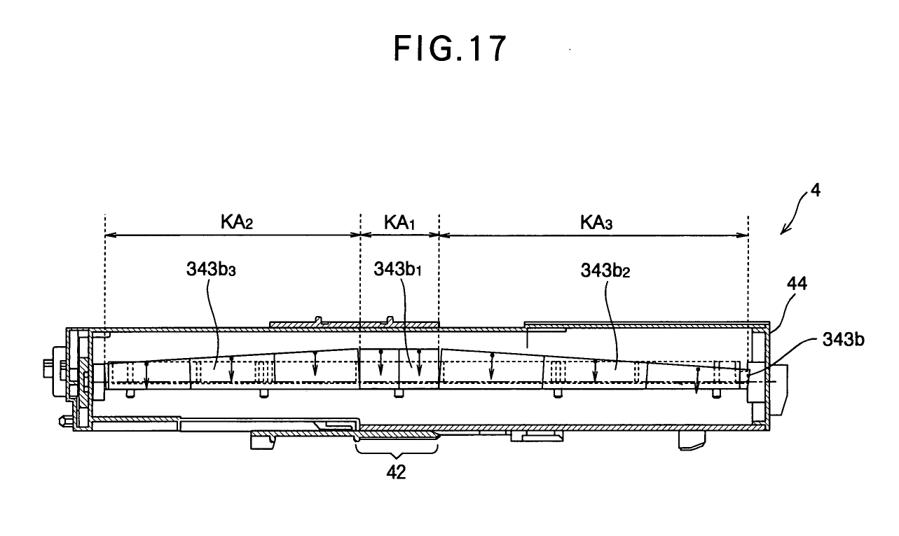

FIG. 17 is a longitudinal sectional view of the toner cartridge 4, taken along line VIII-VIII in FIG. 2. As shown in FIG. 17, outside parts (in the longitudinal direction of the agitating portion 343b) of the agitating portion 343b₂ of the second area KA₂ and the agitating portion 343b₃ of the third area KA₃ sweep the toner stored in the outer frame 41 in a relatively upright manner, and therefore a resistance to the rotation of the agitating-and-supplying member 343 (caused by the toner) is reduced, so that a rotational load of the agitating-and-supplying member 343 is reduced.

Further, during the rotation of the agitating-and-supplying member 343, the agitating portion 343b₂ of the second area KA₂ and the agitating portion 343b₃ of the third area KA₃ shift ahead of (i.e., to a front side of) the agitating portion 343b₁ of the first area KA₁ in the rotating direction of the agitating portion 343. Thus, the toner is caused to move from the agitating portion 343b₂ of the second area KA₂ and the agitating portion 343b₃ of the third area KA₃ toward the agitating portion 343b₁ of the first area KA₁. The toner in the outer frame 41 is collected at the agitating portion 343b₁ of the first area KA₁, and is supplied to the toner hopper 36 via the toner supplying opening 42. Therefore, the toner stored in the outer frame 41 is efficiently supplied to the toner hopper 36 via the toner supplying opening 42.

In the third embodiment, the agitating portion 343b is fixed to the mounting surface 343e of the shaft portion 343a formed as a flat surface. However, it is also possible to mount the agitating portion 343b to a linearly extending shaft connecting the first and second pins 343c and 343d. Alternatively, it is also possible to mount the agitating portion 343b to the mounting surface 43e with inclined surfaces (see FIG. 6) as described in the first embodiment.

### FOURTH EMBODIMENT

Next, the fourth embodiment of the present invention will be described. The fourth embodiment is different from the first embodiment in structures of the toner supplying opening shutter 44 (444) and the agitating portion 43b (443b). Hereinafter, a toner supplying opening shutter 444 and an agitating portion 443b of the fourth embodiment and their related components will be described.

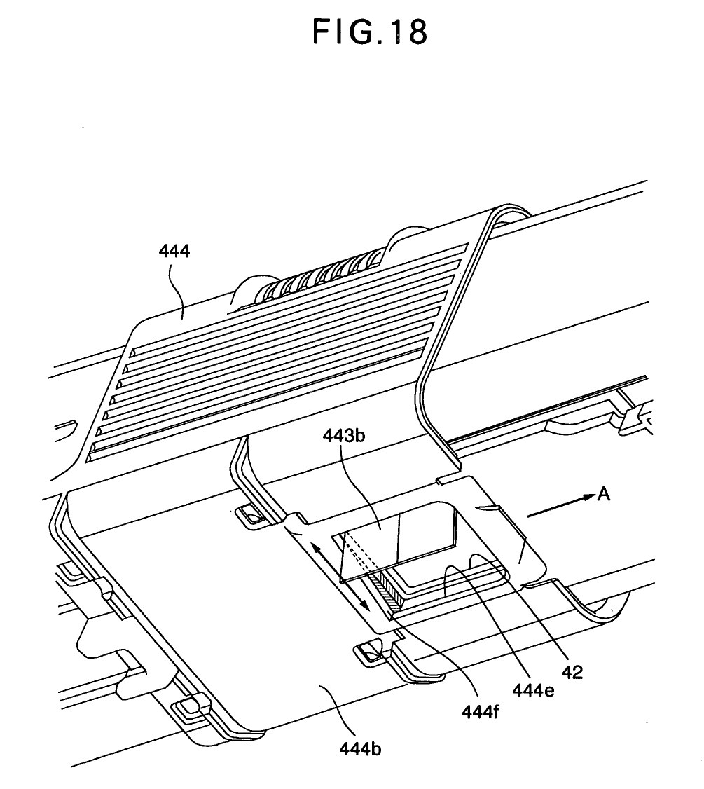

FIG. 18 is a bottom perspective view showing the toner supplying opening shutter 444 and the agitating portion 443b. As shown in FIG. 18, the toner supplying opening shutter 444 of the fourth embodiment has the ejection opening 444e formed on the bottom wall 444b. An inner periphery 444f of the ejection opening 444e (on a rear side in the moving direction of the toner supplying opening shutter 444 to close the toner supplying opening 444e) is inclined with respect to the moving direction of the toner supplying opening shutter 444.

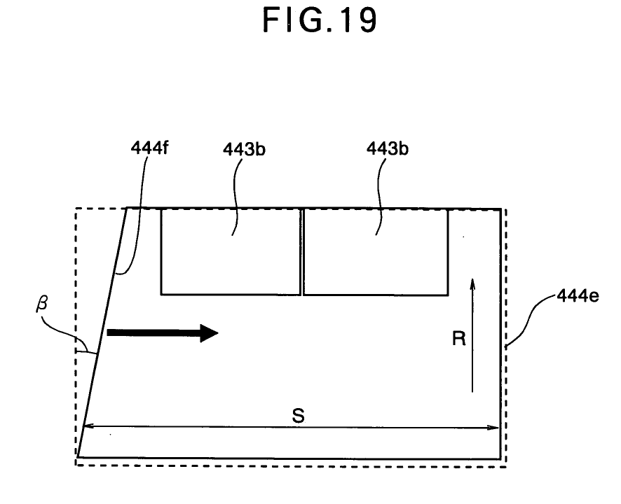

FIG. 19 is a bottom view showing the toner ejection opening 444e. The inner periphery 444f of the toner ejection opening 444e is inclined so that an opening length (indicated by an arrow S) of the ejection opening 444e in the longitudinal direction of the outer frame 41 decreases in a rotating direction of the agitating portion 443b (indicated by an arrow R). In other words, the opening length S of the ejection opening 444e is shorter at a front side (i.e., a downstream side) in the rotating direction of the agitating portion 443b than at a rear side (i.e., an upstream side) in the rotating direction of the agitating portion 443b.

An angle β of the inner periphery 444f with respect to a widthwise direction of the toner supplying opening shutter 444 (perpendicular to the movable direction of the toner supplying opening shutter 444) is preferably in a range from 10 to 45 degrees, and more preferably in a range from 20 to 30 degrees.

The agitating portion 443b of the fourth embodiment is different from the agitating portion 43b of the first embodiment in that the agitating portion 443b has no inclined portion 43g (FIG. 7). The agitating portion 443b of the fourth embodiment is the same as the agitating portion 43b of the first embodiment in other respects.

As described above, according to the fourth embodiment, the inner periphery 444f of the toner ejection opening 444e on the rear side in the moving direction of the toner supplying opening shutter 444 for closing the toner supplying opening 42 is inclined as described above. Therefore, when the toner supplying Opening shutter 444 is moved to close the toner supplying opening 42 in a state where the agitating portion 443b protrudes outside the outer frame 41 via the toner supplying opening 42 and the toner ejection opening 444e, the inner periphery 444f of the toner ejection opening 444e contacts a side edge of the agitating portion 443b, and pushes the agitating portion 443b into the outer frame 41. Thus, the agitating portion 443b is not nipped by the toner supplying opening shutter 444 and the outer frame 41.

Further, according to the fourth embodiment, the agitating portion 443b is not required to have the inclined portion 43g (FIG. 7). Therefore, a relatively large area of the agitating portion 443b protrudes into the toner hopper 36 via the toner supplying opening 42 and the toner ejection opening 444e. Thus, the toner stored in the toner hopper 36 is efficiently pushed toward the feeding spiral 36a (FIG. 2).

While the preferred embodiments of the present invention have been illustrated in detail, it should be apparent that modifications and improvements may be made to the invention without departing from the spirit and scope of the invention as described in the following claims.

What is claimed is:

1. A developer storage container comprising:
a developer storage portion that stores a developer and has an opening for supplying said developer to outside;
an agitating-and-supplying member rotatably provided in said developer storage portion, said agitating-and-supplying member having a shaft portion and an agitating portion, said agitating portion having a fixed end and a distal end opposite to each other, said fixed end of said agitating portion being fixed to said shaft portion,
wherein said agitating portion has an area corresponding to said opening, and
wherein, in said area, a distance between a center axis of said shaft portion and said distal end of said agitating portion is longer than a distance between said center axis of said shaft portion and an outer wall of said developer storage portion.

2. The developer storage container according to claim 1, wherein said agitating portion is constituted by a resilient member that protrudes from said shaft portion toward an inner surface of said developer storage portion.

3. The developer storage container according to claim 2, wherein said agitating portion is formed of a film member, and said agitating portion contacts said inner surface of said developer storage portion in a deflected manner.

4. The developer storage container according to claim 3, wherein said agitating portion of said area protrudes outside said developer storage portion via said opening, and
wherein said agitating portion of other area contacts said inner surface of said developer storage portion in a deflected manner.

5. The developer storage container according to claim 4, wherein said agitating portion of said area is separated from said agitating portion of other area by slits.

6. The developer storage container according to claim 5, wherein, wherein a length of said agitating portion of said area in a direction parallel to a center axis of said shaft portion is smaller than a length of said opening in the same direction.

7. The developer storage container according to claim 4, wherein a distance between said fixed end and said distal end of said agitating portion of said area is longer than a distance between said fixed end and said distal end of said agitating portion of other area.

8. The developer storage container according to claim 1, wherein a distance between said fixed end to said distal end of said agitating portion gradually decreases as a distance from said area (KA₁) increases.

9. The developer storage container according to claim 1, further comprising a shutter provided on said developer storage portion so as to be movable in a longitudinal direction of said developer storage portion,
wherein said shutter is movable between a first position where said shutter covers said opening, and a second position where said shutter opens said opening.

10. The developer storage container according to claim 4, wherein, in a state where said agitating portion of said area protrudes outside said developer storage portion via said opening, said agitating portion of said area contacts an inner periphery of said opening, and said distal end of said agitating portion positions at a rear side with respect to said inner periphery of said opening in a rotating direction of said agitating-and-supplying member.

11. The developer storage container according to claim 1, wherein a length of said agitating portion in a direction parallel to said center axis of said shaft portion is shorter at said distal end than at said fixed end.

12. A developing device comprising said developer storage container according to claim 1.

13. An image forming apparatus comprising said developer storage container according to claim 1.
